(19) United States
(12) Patent Application Publication
(10) Pub. No.: US 2004/0080679 A1
(43) Pub. Date: Apr. 29, 2004

(54) Liquid crystal display and fabricating method thereof

(76) Inventors: Hong Sung Song, Kumi-shi (KR); June Ho Park, Kumi-shi (KR); Sang Moo Song, Nam-ku (KR)

Correspondence Address: Song K. Jung, McKenna Long & Aldridge LLP, Attorneys At Law, 1900 K Street, N.W., Washington, DC, 20006, US

(21) Appl. No.: 10/664,972

(22) Filed: Sep. 22, 2003

(30) Foreign Application Priority Data
Oct. 24, 2002 (KR) 2002-65218

(51) Int. Cl. G02F 1/136

(52) U.S. Cl. 349/43

(57) ABSTRACT

A liquid crystal display capable of reducing power consumption includes liquid crystal cells arranged in a matrix at crossings of a plurality of gate lines and data lines, a thin film transistor connected to the data lines in an alternating pattern based upon an arrangement of the data lines included in the liquid crystal cells, a data driver configured to supply a video signal to the liquid crystal cells and shift the video signal by one channel to the right to drive the data lines, and an interlayer-insulation material formed by organic insulation film having a dielectric constant below about 4. The interlayer-insulation material may be located between the data line and a pixel electrode formed in each of the liquid crystal cells.

This application claims the benefit of Korean Patent Application No. 2002-65218, filed on Oct. 24, 2002, which is hereby incorporated by reference for all purposes as if fully set forth herein.

### BACKGROUND OF THE INVENTION

1. Field of the Invention

The present invention relates to a liquid crystal display and a fabricating method. More particularly, the invention relates to a liquid crystal display and fabricating method capable of decreasing power consumption and improving picture quality.

2. Discussion of the Related Art

The liquid crystal display of an active matrix represents a natural moving picture by using a thin film transistor (hereinafter referred to as “TFT”) as a switching device. Such a liquid crystal display has a small size in contrast to a cathode ray tube, and may be commercialized as a monitor for a television, a notebook computer or a personal computer.

With respect to the liquid crystal display of the active matrix type, pixels represent an image that corresponds to a video signal, such as a television signal, at a picture element matrix or pixel matrix arranged at each of the crossings of gate lines and data lines. Each of the pixels comprise the liquid crystal cell controlling the amount of a transmission light beam in accordance with a voltage level of a data signal from the data line. The TFT is arranged at the crossings of the gate lines and the data lines and switches a data signal transmitted to the liquid crystal cell in response to a scan signal (gate pulse) from the gate line.

FIG. 1 schematically illustrates a related art liquid crystal display.

As shown in FIG. 1, the related art liquid crystal display comprises a liquid crystal display panel 2, a TFT formed at each crossing of n number of gate lines (GL1 to GLn) and m number of data lines (DL1 to DLm), a gate driver 4 for driving the gate lines (GL1 to GLn) and a data driver 6 for driving the data lines (DL1 to DLm).

The TFT responds to the gate signal from the gate line (GL) and supplies a video signal from the data line (DL) to the liquid crystal cells. The liquid crystal display cell may be represented equally as a common electrode (not shown) facing the pixel electrode with liquid crystal material therebetween and a liquid crystal capacitor including a pixel electrode 8 connected to the TFT.

The gate driver 4 sequentially supplies a gate signal to the gate lines (GL1 to GLn) to drive the TFT connected to a corresponding gate line. The data driver 6 converts the video data into a video signal which is an analog signal and supplies the video signal of one horizontal line to the data lines (DL1 to DLm) during one horizontal period where the gate signal is supplied to the gate line (GL). In this case, the data driver 6 converts the video data into the video signal by using gamma voltages supplied from a gamma voltage generator (not shown). The liquid crystal display represents the image by controlling light transmittance of the liquid crystal in accordance with a voltage, namely, an electric field of vertical direction applied to a pixel electrode 8 and the common electrode (not shown).

Such a liquid crystal display uses an inversion driving method such as a frame inversion method, a line inversion method, a column inversion method, and a dot inversion method in order to drive the liquid crystal cells on the liquid crystal display panel.

The driving method of the liquid crystal display panel employing the frame inversion method, as shown in FIGS. 2A and 2B, inverts the polarity of the video signal supplied to the liquid crystal cells on the liquid crystal panel whenever the frame is changed. The frame inversion method has an advantage of being driven by low power consumption in contrast to the other driving methods (that is, the line inversion method, the column inversion method, and dot inversion method). However, the frame inversion method has a defect that a flicker arises in the frame.

With respect to the liquid crystal panel driving method of the line inversion method, the polarity of the video signals supplied to the liquid crystal panel, as shown in FIGS. 3A and 3B, are inverted in accordance with the gate line on the liquid crystal panel and in turn the frame. The line inversion driving method has a disadvantage that the flicker between horizontal lines arises since a cross talk exists between pixels in the horizontal direction.

With respect to the liquid crystal panel driving method of the column inversion method, the polarity of the video signals supplied to the liquid crystal panel, as shown in FIGS. 4A and 4B, are inverted in accordance with the data line on the liquid crystal panel and in turn the frame. The column inversion driving method has a defect in which a flicker, such as a line pattern between vertical lines, arises because cross talk exists between pixels in the vertical direction.

The liquid crystal display panel driving method of the dot inversion method, as shown in FIGS. 5A and 5B, supplies a video signal having a polarity opposite to all the liquid crystal cells adjacent to the horizontal and the vertical direction to each of the liquid crystal cells to reversely invert the polarity of the video signal between frames.

In other words, when the video signal of odd-numbered frames are represented with respect to the dot inversion method, as shown in FIG. 5A, the video signals are supplied to the liquid crystal cell so that a positive (+) and a negative (−) polarity may occur alternately along the direction from the liquid crystal cell on a left upper end to the liquid crystal cell on the right side and in turn the liquid crystal cells on a lower side.

When the video signal of even-numbered frames are represented, as shown in FIG. 5B, the video signals are supplied to the liquid crystal cell so that a negative (−) and a positive (+) polarity may occur alternately along the direction from the liquid crystal cell on a left upper end to the liquid crystal cell on the right side and in turn the liquid crystal cells on a lower side.

In the dot inversion method as set forth above, a flicker is generated in a vertical and a horizontal direction, and between the frames (or fields) is offset, so an excellent picture quality is provided.

However, in the dot inversion method, the polarities of the video signals supplied to the data lines in the data driver have to be inverted to the horizontal direction and the vertical direction. As a result, the dot inversion method has a drawback that a change quantity of the pixel voltage, that is, a frequency of the video signal is large in contrast with the other inversion methods, which leads a high power consumption.

### SUMMARY OF THE INVENTION

Accordingly, the present invention is directed to a liquid crystal display and a fabricating method thereof that substantially obviate one or more of the problems due to limitations and disadvantages of the related art.

An advantage of the present invention is to provide a liquid crystal display and method capable of decreasing power consumption and improving picture quality.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof, as well as the appended drawings.

To achieve these and other advantages and in accordance with the purpose of the present invention, as embodied and broadly described, the liquid crystal display according to an aspect of the present invention includes liquid crystal cells arranged in a matrix type at the crossings of a plurality of gate lines and data lines; a thin film transistor connected to one of the plurality of data lines in a zigzag fashion on a basis of the data lines included in the liquid crystal cell respectively; a data driver for supplying a video signal that shifts the video data by one channel to the right to drive the data line; and a interlayer-insulation material formed by an organic insulation film having a dielectric constant less than 4 between the data line and the pixel electrode associate with each liquid crystal cell.

In another aspect of the present invention, a method of fabricating a liquid crystal display comprises forming a plurality of gate electrodes and gate lines on a lower substrate; forming a gate insulation film on the lower substrate to cover the gate electrodes and the gate lines; forming a semiconductor layer to overlap with the gate electrodes on the gate insulation film; forming a source electrode and a drain electrode to connect with the semiconductor layer; forming data lines so that liquid crystal cells and the gate lines may be divided in a matrix form and connected to the source electrode; forming an organic insulation film having a dielectric constant less than 4 to cover the data line, the source electrode and the drain electrode; and forming a pixel electrode on the organic insulation film, wherein the pixel electrode is arranged in each location of the partitioned liquid crystal cell.

In a further aspect of the present invention, a liquid crystal display, comprises liquid crystal cells arranged in a matrix defined by a plurality of gate lines and data lines; a thin film transistor connected to the data lines in an alternating pattern based upon an arrangement of the data lines included in the liquid crystal cells; a data driver supplying a video signal to the liquid crystal cells and shifting the video signal by one channel to the right to drive the data lines; a pixel electrode associated with each of the liquid crystal cells, the pixel electrode having a rectangular shape; and an interlayer-insulation material formed by an organic insulation film having a dielectric constant less than about 4 and located between the data line and the pixel electrode associated with each of the liquid crystal cells.

It is to be understood that both the foregoing general description and the following detailed description are exemplary and explanatory and are intended to provide further explanation of the invention as claimed.

### BRIEF DESCRIPTION OF THE DRAWINGS

These and other objects of the invention will be apparent from the following detailed description of the embodiments of the present invention with reference to the accompanying drawings, in which:

FIG. 1 schematically illustrates a related art liquid crystal display;

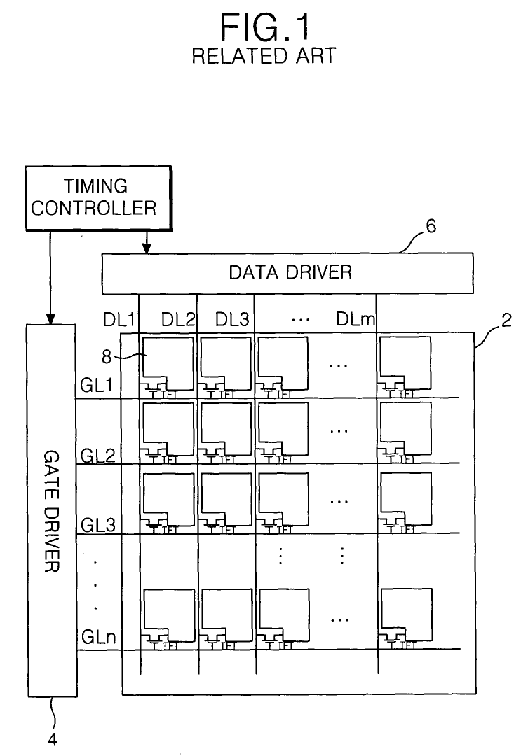

FIGS. 2A and 2B illustrate a method of driving a liquid crystal display according to frame inversion;

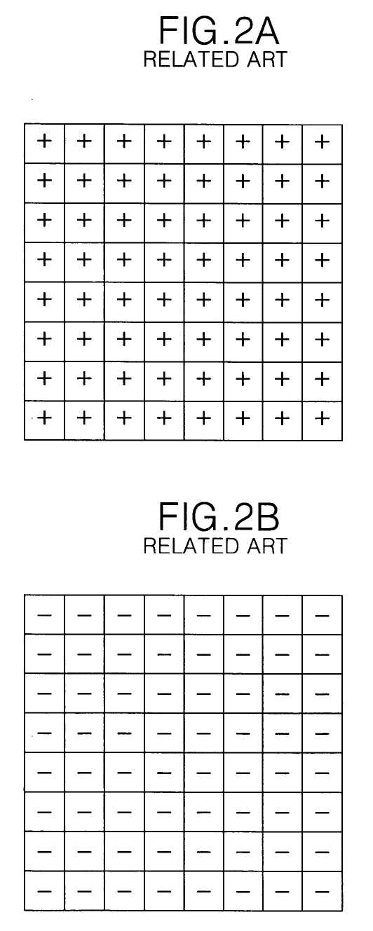

FIGS. 3A and 3B illustrate a method of driving a liquid crystal display according to line inversion;

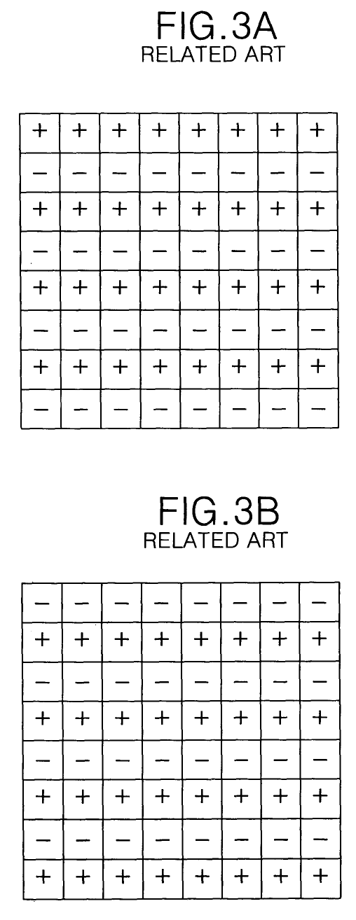

FIGS. 4A and 4B illustrate a method of driving a liquid crystal display according to column inversion;

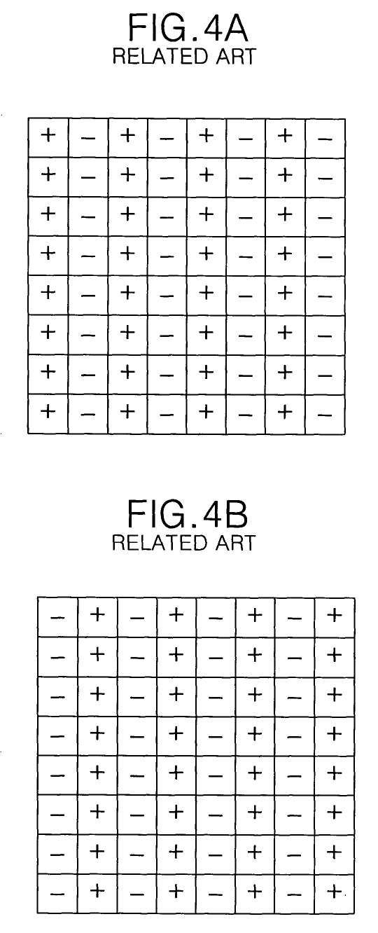

FIGS. 5A and 5B illustrate a method of driving a liquid crystal display according to dot inversion;

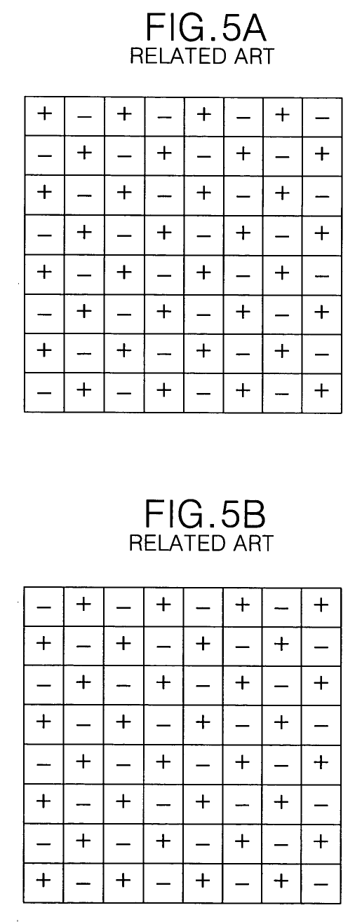

FIG. 6 illustrates a liquid crystal display according to a first embodiment of the present invention;

FIGS. 7A and 7B illustrate a capacitor formed in a liquid crystal cell as shown in FIG. 6;

FIG. 8 illustrates a light generated from a liquid crystal display of FIG. 6;

FIG. 9 illustrates a liquid crystal display according to a second embodiment of the present invention;

FIG. 10 illustrates a liquid crystal display according to a third embodiment of the present invention;

FIG. 11 illustrates a light generated from the liquid crystal display of FIG. 9;

FIG. 12 illustrates a liquid crystal display according to a fourth embodiment of the present invention;

FIG. 13 illustrates a liquid crystal display according to a fifth embodiment of the present invention;

FIG. 14 illustrates a liquid crystal display according to a sixth embodiment of the present invention; and

FIG. 15 illustrates a liquid crystal display according to a seventh embodiment of the present invention.

### DETAILED DESCRIPTION OF THE ILLUSTRATED EMBODIMENTS

Reference will now be made in detail to the preferred embodiments of the present invention, examples of which are illustrated in the accompanying drawings.

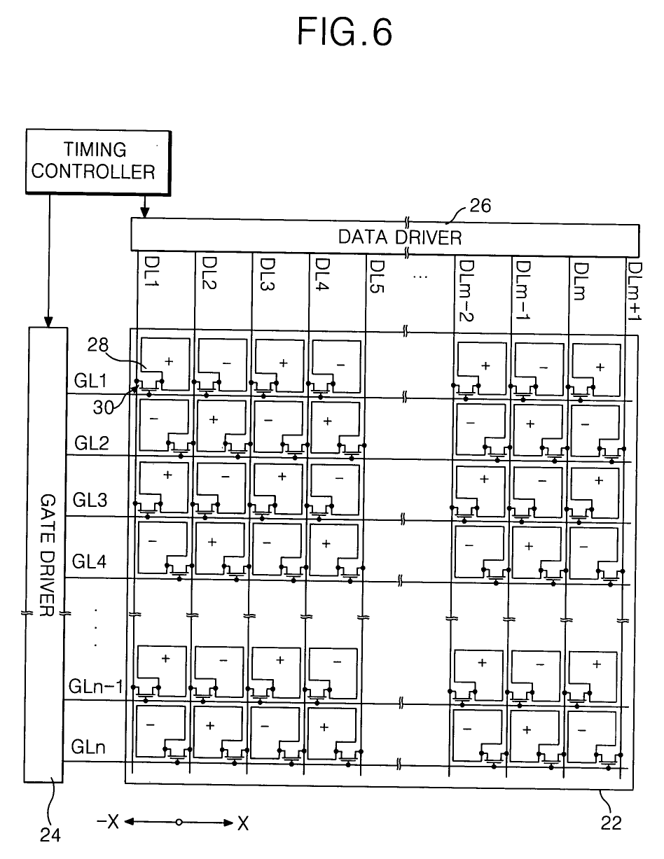

FIG. 6 illustrates a liquid crystal display according to a first embodiment of the present invention.

Referring to FIG. 6, the liquid crystal display according to the first embodiment of the present invention includes a liquid crystal display panel 22 in which liquid crystal cells are arranged in a matrix, a gate driver 24 for driving the gate lines (GL1 to GLn) of the liquid crystal display panel 22, and a data driver 26 for driving the data lines (DL to DLm+1) of the liquid crystal display panel 22.

The liquid crystal display panel 22 includes a plurality of crossing gate lines (GL1 to GLn) and data lines (DL1 to DLm+1). At each crossing of the gate lines (GL1 to GLn) and the data lines (DL1 to DLm+1), the liquid crystal cells are arranged in a matrix. Each of the liquid crystal cells includes a TFT 30 connected to any one of the n numbers of the gate lines (GL1 to GLn) and any one of the m+1 numbers of the data lines (DL1 to DLm+1).

Since the TFT 30 is arranged in an alternating fashion along the data lines (DL1 to DLm+1), the liquid crystal cells are connected to each of the data lines (DL1 to DLm+1) in an alternating fashion. In other words, the liquid crystal cells included in the same column are respectively connected to a data line (DL) different from each other adjacent liquid crystal cell in the column.

For example, the liquid crystal cells of odd-numbered horizontal lines connected to odd-numbered gate lines (GL1, GL3, GL5, . . . ) are respectively connected to 1 to m data lines (DL1 to DLm) located in the −X axis direction. While liquid crystal cells of even-numbered horizontal lines connected to even-numbered gate lines (GL2, GL4, GL6, . . . ) are respectively connected to the m+1 data lines (DL2 to DLm+1) located in the +X axis direction.

Therefore, odd-numbered data lines (DL1, DL3, . . . ) are alternately connected to odd-numbered liquid crystal cells and to even-numbered liquid crystal cells for each horizontal line in the horizontal direction. And even-numbered data lines (DL2, DL4, . . . ) are alternately connected to even-numbered liquid crystal cells and to odd-numbered liquid crystal cells in the horizontal direction for each horizontal line.

The TFT 30, in response to a gate signal from a gate line (GL1 to GLn), supplies a video signal from a data line (DL1 to DLm+1) to the liquid crystal cells. The liquid crystal cells, in response to the video signal, drives a liquid crystal located between the common electrode (not shown) and the pixel electrode 28 to control the transmittance of the light.

The gate driver 24 sequentially supplies a gate signal to the gate lines (GL1 to GLn) to drive the thin film transistor (TFT) 30 connected to its corresponding gate line.

The data driver 26 converts the video data provided in the video signal, which is an analog signal, and supplies the video signal of one horizontal line during one horizontal period in which the gate signal is supplied to the gate line (GL) to the data lines (DL1 to DLm+1). In this connection, the video data is converted by the data driver 26 into the video signal by using gamma voltages supplied from a gamma voltage generator (not shown). And the data driver 26 may supply the converted video signal to the data lines (DL1 to DLm+1) in accordance with a column inversion driving method.

In other words, the data driver 26 supplies the video signals having opposite polarities to the odd-numbered data lines (DL1, DL3, . . . ) and to even-numbered data lines (DL2, DL4, . . . ) during one frame. More specifically, the data driver 26 supplies the video signal to each horizontal term for the liquid crystal cells arranged in an alternating fashion using the data lines (DL1 to DLm+1) as a basis, or supplies the signal as being shifted by one channel to the right. In other words, the data driver 26 is driven by the column inversion method and by means of supplying the video signal as it is to every horizontal term or supplying the video signal as being shifted by one channel to the right. The liquid crystal cells arranged in an alternating fashion in accordance with the data lines (DL1 to DLm+1) may also be driven by the dot inversion method.

For example, in a case in which the data driver 26 drives the liquid crystal display panel 22 shown in FIG. 6, while the video signal of the odd-numbered horizontal line is respectively supplied to the 1 to the m data lines (DL1 to DLm), the video signal of the even-numbered horizontal line is shifted to the right by the one channel and is respectively supplied to the 2 to the m+1 data lines (D12 to DLm+1).

Explaining this in full detail, the data driver 26 supplies the video signal of a positive (+) polarity to the odd-numbered liquid crystal cells through odd-numbered data lines (DL1, DL3, . . . ) using one horizontal term where one gate line (GL1) is driven; while the data drives supplies the video signal of a negative (−) polarity to even-numbered liquid crystal cells through even-numbered data line (DL2, DL4, . . . ). Subsequently, the data driver 26 shifts the video signal of the negative (−) polarity to the right by one channel where the second gate line (GL2) is driven to provide the shifted video signal to odd-numbered liquid crystal cells using even-numbered data lines (DL2, DL4, . . . ) to shift the video signals. Data driver 26 supplies the video signal of the positive (+) polarity to the even-numbered liquid crystal cells via odd-numbered data lines (DL3, DL5, . . . ) except for the first data line (DL1). In this scenario, the data driver 26 is driven by the column inversion method and shifts the video signal by a clock signal for every even-numbered horizontal line, by means of supplying the shifted video signal to the liquid crystal cells arranged in an alternating fashion in accordance with the data lines (DL1 to DLm+1). In the alternative, the liquid crystal cells of the liquid crystal display panel 22 may be driven by the data driver 26 using a dot inversion method.

More particularly, the liquid crystal display according to the first embodiment of the present invention may be driven using the dot inversion method by similarly employing the data driver 26 described above as driven by the column inversion method, since the liquid crystal cells are arranged in an alternating fashion along the data lines. Therefore, since the liquid crystal display according to the first embodiment of the present invention drives the liquid crystal display panel by the dot inversion method, the power consumption can be reduced in contrast to a case in which the conventional dot inversion data driver is used.

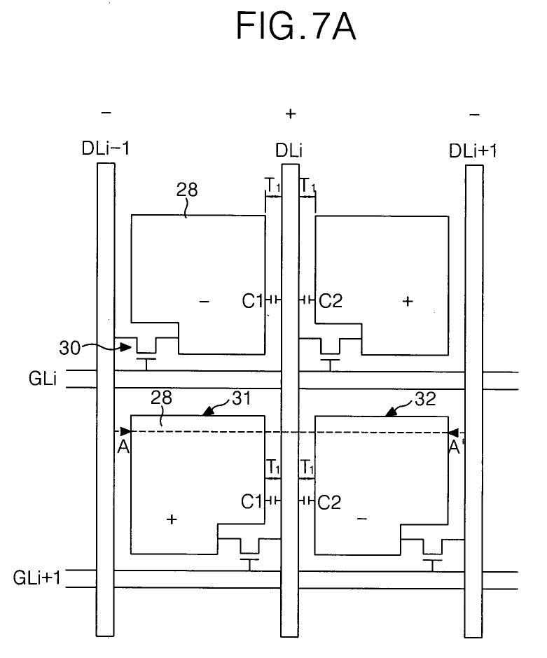

However, in the liquid crystal display according to the first embodiment of the present invention, owing to a capacitance formed equally between liquid crystal cells formed at the data line and right/left of the data line (DL), a problem arises with the difference in brightness between lines. Referring to FIGS. 7A and 7B, this problem is explained in detail. As the liquid crystal display according to the first embodiment of the present invention is driven using the column inversion method, the iₜₕ data line (DLi) (i is a natural number) keeps one polarity (Here it is assumed that the polarity is a positive polarity (+)) during one frame.

At this time, a first liquid crystal cell 31 located at the left of the iₜₕ data line (DLi) in the iₜₕ horizontal line is provided the video signal of positive polarity (+). Further, a second liquid crystal cell 32 located at the right of the iₜₕ data line (DLi) in the (I+1)ₜₕ horizontal line is provided with the video signal of the negative polarity (−). A set of the iₜₕ data line (DLi) and the first liquid crystal cell 31, and a set of the iₜₕ data line (DLi) and the second liquid crystal cell 32 are respectively separated by an interval of T1. Accordingly, a first capacitor (C1) is formed between the first liquid crystal cell 31 and the iₜₕ data line (DLi), and a second capacitor (C2) is formed between the second liquid crystal cell 32 and the iₜₕ data line (DLi). The first capacitor (C1) may be spaced substantially equal distance from the first liquid crystal cell 31 and the iₜₕ data line (Dli), and the second capacitor (C2) may be spaced substantially equal distance from the second liquid crystal cell 32 and the iₜh data line (DLi).

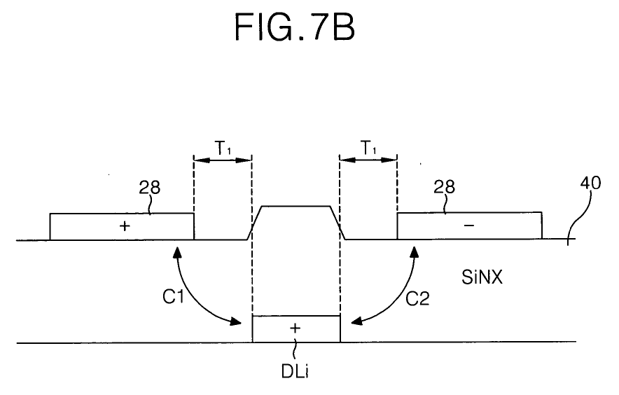

Since the iₜₕ data line (DLi) and the first liquid crystal cell 31 have a voltage of the same polarity, the first capacitor (C1) has a first capacitance. However, the second capacitor (C2) may have a second capacitance that is larger than the first capacitance since the iₜₕ data line (DLi) and the liquid crystal cell 32 have a different polarity to each other. Therefore, if the capacitance value between the first liquid crystal cell 31 and the second liquid crystal cell 32 located adjacent to the data line (DLi) differs, as shown in FIG. 8, the brightness of a light between liquid crystal cells (between lines) begins to differ. In other words, as shown in FIG. 8, between the second liquid crystal cell 32 and the iₜₕ data line (DLi), the light having the high brightness may be generated and thus the picture quality is deteriorated.

As described above, in the first embodiment of the present invention, the phenomenon where the picture quality is deteriorated is generated by the high capacitance between the liquid crystal cells 31, 32 and the data line (DLi). Explaining this in full detail, in FIG. 7B, silicon nitride (SiNx) is used as an interlayer-insulation material 40 between the data line (DLi) and the pixel electrode 28. Since the silicon nitride (SiNx) has a high dielectric constant (approximately 6.7), a high capacitance occurs between the liquid crystal cells and the data line (DL). The high capacitance existing between the liquid crystal cells and the data line (DL) limits the movement of the liquid crystal, and thus the brightness of the liquid crystal display panel 22 is deteriorated.

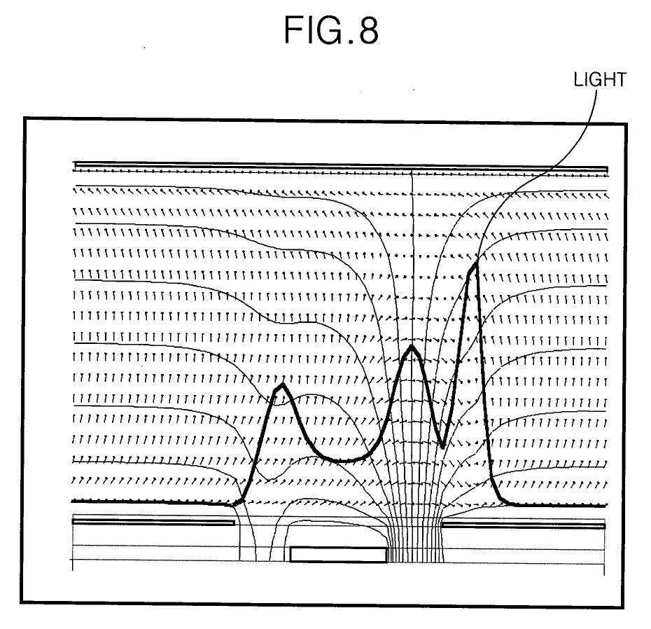

To prevent the deterioration of the brightness induced by the capacitance, the liquid crystal display according to a second embodiment of the present invention is illustrated in FIG. 9. The liquid crystal display according to the second embodiment of the present invention shown in FIG. 9 has the same structure as the liquid crystal display according to the first embodiment of the present invention. The difference between the two embodiments is that in the second embodiment (FIG. 9) of the present invention an organic insulation film having a low dielectric constant below about 4 is used as interlayer-insulation material. For example, in the second embodiment of the present invention a benzocyclobutene (BCB) having a dielectric constant of about 2.6 may be used as the interlayer-insulation material 44. Here, a third capacitor (C3) may be substantially formed equally between the first pixel electrode 42 and the data line (DL), and a fourth capacitor (C4) may be substantially formed equally between the second pixel electrode 43 and the data line (DL) and have a capacitance lower than the first and the second capacitor (C1, C2) of the first embodiment illustrated in FIG. 7B. The interlayer-insulation material 44 of FIG. 9, having a low dielectric constant, may be disposed between the third and the fourth capacitors (C3, C4).

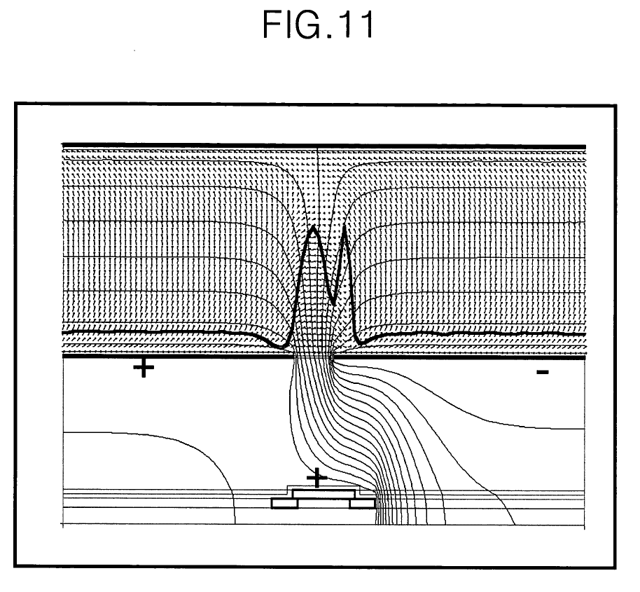

The third capacitor (C3) and the fourth capacitor (C4) having a low capacitance prevent the direction of the liquid crystal from changing by the capacitance value. In other words, in accordance with the second embodiment of the present invention, since the third capacitor (C3) and the fourth capacitor (C4) have a low capacitance, the direction of the liquid crystal is prevented from changing and thus, a picture having an uniform brightness between liquid crystal cells can be represented. For example, in the second embodiment of the present invention, as shown in FIG. 11, the uniform brightness between liquid crystal cells is represented.

A fabrication method of the liquid crystal display according to the second embodiment of the present invention is described below. First, a plurality of gate lines and gate electrodes are formed on a lower substrate. After a plurality of gate lines and electrodes are formed on the lower substrate, a gate insulation film is formed on the gate lines and electrodes. A semiconductor layer is formed on the gate insulation film. A data line (a source electrode) is formed in contact with this semiconductor layer. Later, an interlayer-insulation material 44 (or protection film) having a low dielectric constant is formed on the data line, and pixel electrodes 42, 43 are formed on the interlayer-insulation material 44.

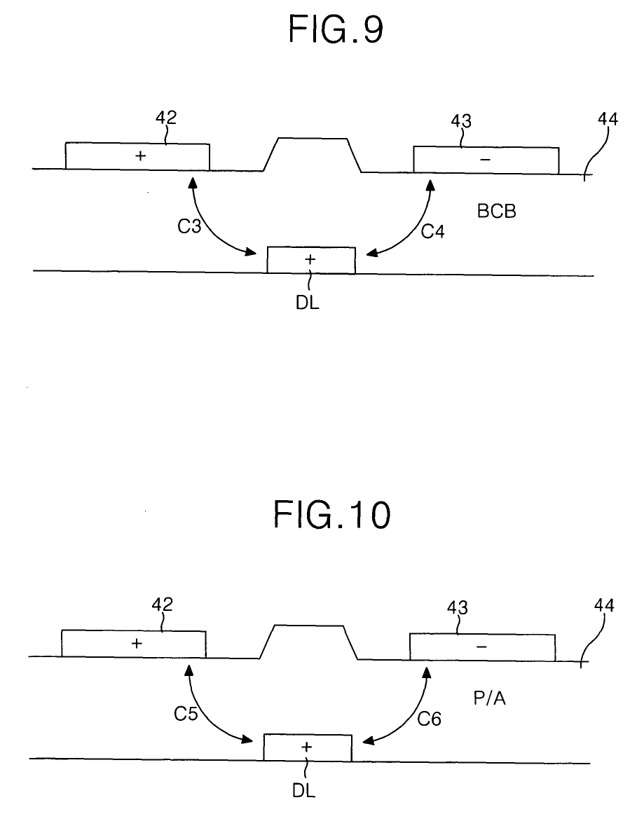

The interlayer-insulation material of the present invention may be formed with various materials. For example, with respect to an embodiment of the present invention, as shown in FIG. 10 in a third embodiment of the present invention, the interlayer-insulation material 44 may be an acryl resin, for example, a photo acryl (P/A), having a dielectric constant of about 3.4. In FIG. 10, a fifth capacitor (C5) formed between the first pixel electrode 42 and the data line (DL), and the sixth capacitor (C6) formed between the second pixel electrode 43 and the data line (DL) have a low capacitance that is lower than that of the first and the second capacitor (C1, C2) of the first embodiment of FIG. 7B, and the photo acryl (P/A) may be disposed between the fifth and the sixth capacitors (C5, C6).

If the fifth capacitor (C5) and the sixth capacitor (C6) have a low capacitance, the direction of the liquid crystal is prevented from being changed by the capacitance value. In other words, with respect to the third embodiment of the present invention, the low capacitance of the fifth capacitor (C5) and the sixth capacitor (C6) prevents the direction of the liquid crystal from changing and thereby, the picture has a uniform brightness between liquid crystal cells.

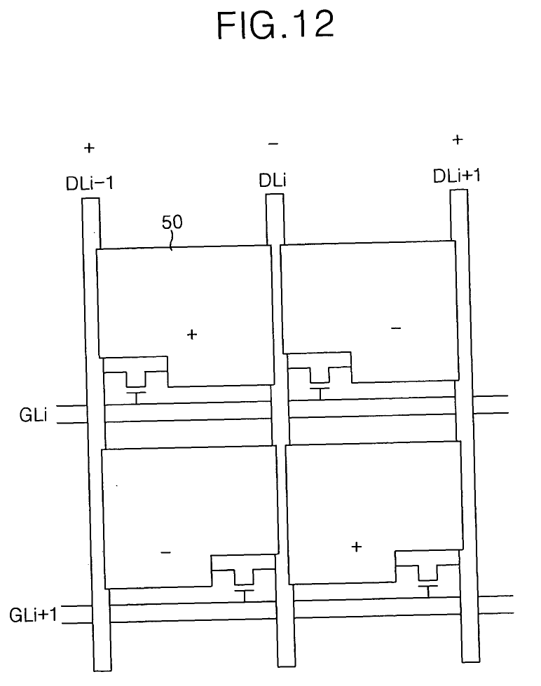

On the other hand, as illustrated in FIG. 12, when the interlayer insulation material 44 has a high dielectric constant between the pixel electrode and the data line (DL), the pixel electrode 50 and the data line (DL) may be overlapped (he fourth embodiment of the present invention). As illustrated in FIG. 7a, the pixel electrode 28 and the data line (DL) may be formed to be separated as much as designated interval (T1). In other words, in order to lower the capacitance formed between the pixel electrode 28 and the data line (DL), the pixel electrode 28 and the data line (DL) may be formed to be separated as a much as designated interval. In a case such as that illustrated in the second and the third embodiments of the present invention, when the interlayer insulation material 44 formed between the data line (DL) and the pixel electrodes 42, 43 has a low dielectric constant, a low capacitance may be maintained between the pixel electrodes 42, 43 and the data line (DL). However, as illustrated in FIG. 12, by superimposing the pixel electrode 50 and the data line (DL) located to the right/left of the pixel electrode 50, a high aperture ratio may be formed in the liquid crystal display. The pixel electrode 50 may be overlapped with any one of the data lines located to the right/left of the pixel electrode 50.

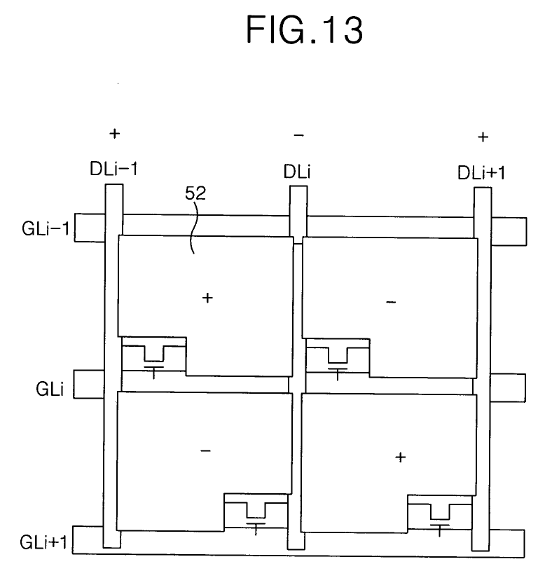

Similarly, in accordance with the present invention, as illustrated in FIG. 13, a pixel electrode 52 may be overlapped with the data line (DL) and the gate line (GL) disposed at the up/down thereof in a fifth embodiment of the present invention. The pixel electrode 52 formed in the iₜₕ horizontal line and the i−1ₜₕ column line may be overlapped with the iₜₕ gate line (GLi) and the i−1ₜₕ gate line (GLi−1). Further, the pixel electrode 52 formed in the iₜₕ horizontal line and the i−1ₜₕ column line may be overlapped with the iₜₕ data line (DLi) and the i−1ₜₕ data line (DLi−1). When the pixel electrode 52 is overlapped with the data line (DL) and the gate line (GL) adjacent thereto, the liquid crystal display has a high aperture ratio. As shown in FIG. 13, the pixel electrode 52 may be overlapped with any one of the gate lines adjacent in the up/down direction of the pixel electrode. Similarly, the pixel electrode 52 may be overlapped with any one of the data lines adjacent in the right/left direction thereof.

The fabricating method for a LCD as illustrated in FIGS. 12 and 13 is explained below. First, a plurality of gate lines are formed on the lower substrate. After a plurality of gate lines are formed on the lower substrate, the gate insulation film is formed on the gate lines. Then, the semiconductor layer is formed on the gate insulation film and the data line (source electrode) is formed in contact with the semiconductor layer. The interlayer-insulation material (or protection film), having a low dielectric constant, is formed on the data line and the pixel electrodes are formed on the interlayer-insulation material. The pixel electrodes may be overlapped with at least more than one of the data line adjacent in the right/left thereof and the gate line adjacent in the up/down thereof.

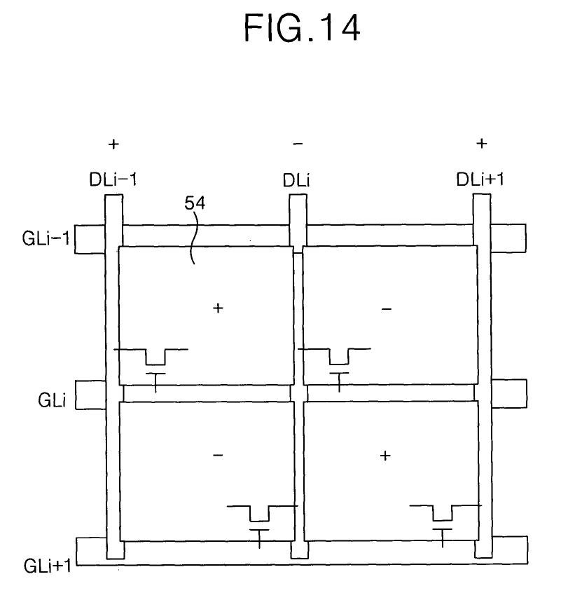

In accordance with a sixth embodiment of the present invention, as illustrated in FIG. 14, the pixel electrode 54 can be overlapped with a TFT. In such a case, the pixel electrode 54 formed in the iₜₕ horizontal line and the i−1ₜₕ column line may be overlapped with the iₜₕ gate line (GLi) and the i−1ₜₕ gate line (GLi−1), and may also overlap the TFT. Further, the pixel electrode 54 formed in the iₜₕ horizontal line and the i−1ₜₕ column line may be overlapped with the iₜₕ data line (DLi) and the i−1ₜₕ data line (DLi−1).

When the pixel electrode 54 is overlapped with the adjacent data line (DL), the gate line (GL), and the TFT, the liquid crystal display has a high aperture ratio. As illustrated in FIG. 14, the pixel electrode 54 may be overlapped with at least more than one of the gate lines adjacent in the up/down direction. Similarly, the pixel electrode 54 may be overlapped with at least more than one of the data lines adjacent in the right/left direction.

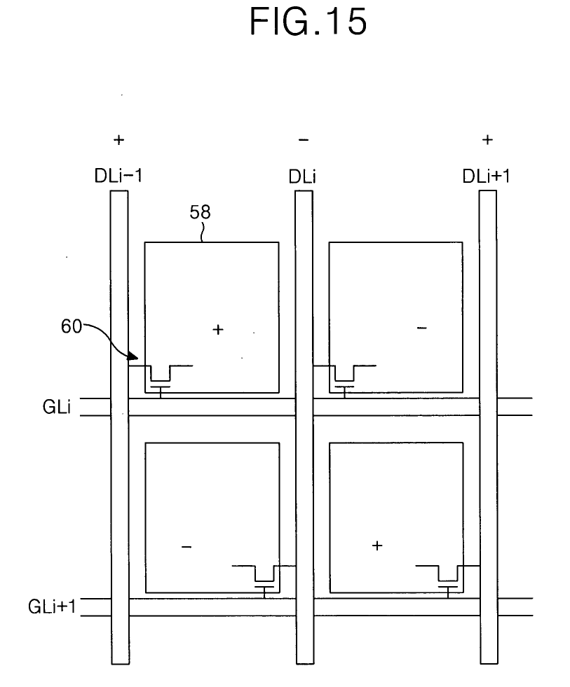

FIG. 15 illustrates a seventh embodiment of the present invention in which a pixel electrode 58 may not be superimposed with the adjacent data line (DL) and gate line (GL), but may be overlapped with the TFT 60.

A fabricating method for a LCD as illustrated in FIGS. 14 and 15 is explained below. First, a plurality of gate lines are formed on the lower substrate (the gate electrode of the TFT may be formed at the same time). After a plurality of gate lines are formed on the lower substrate, a gate insulation film is formed on the gate lines. Then, a semiconductor layer is formed on the gate insulation film and the data line (source electrode) and the drain electrode are formed in contact with the semiconductor layer. Later, a interlayer-insulation material (or protection film) having a low dielectric constant is formed on the data line, and pixel electrodes are formed on the interlayer-insulation material. The pixel electrodes may be overlapped with at least more than one of the data line adjacent in the right/left direction and the gate line adjacent in the up/down direction. Additionally, the pixel electrodes may be overlapped with the TFT.

As described above, in accordance with the liquid crystal display according to the present invention, by arranging the liquid crystal cells in an alternating fashion with respect to the data lines and supplying the video signal in a column inversion method, the liquid crystal display panel is driven by the dot inversion method. Accordingly, the liquid crystal display of the present invention can decrease power consumption. Further, an organic insulation film having a low dielectric constant below about 4 may be used as an interlayer-insulation film between the pixel electrode and the data electrode. A capacitance between the pixel electrode and the data line may be decreased and the picture quality improved when the organic insulation film having a low dielectric constant is used as the interlayer-insulation film. Further, if the organic insulation film having a low dielectric constant is used as a interlayer-insulation film, a liquid crystal display having a high aperture ratio may be attained by superimposing at least more than one of the pixel electrode and the data line, the pixel electrode and the gate line, and the pixel electrode and the TFT.

Although the present invention has been explained by the embodiments shown in the drawings described above, it will be apparent to those skilled in the art that various modifications and variations can be made in the present invention without departing from the spirit of the invention. Thus, it is intended that the present invention cover the modifications and variations of this invention provided they come within the scope of the appended claims and their equivalents.

What is claimed is:

1. A liquid crystal display, comprising:
liquid crystal cells arranged in a matrix defined by a plurality of gate lines and data lines;
a thin film transistor connected to the data lines in an alternating pattern based upon an arrangement of the data lines included in the liquid crystal cells;
a data driver supplying a video signal to the liquid crystal cells and shifting the video signal by one channel to the right to drive the data lines;
a pixel electrode associated with each of the liquid crystal cells; and
an interlayer-insulation material formed by an organic insulation film having a dielectric constant less than about 4 and located between the data line and the pixel electrode associated with each of the liquid crystal cells.

2. The liquid crystal display according claim 1, wherein the interlayer-insulation material includes a benzocyclobutene (BCB).

3. The liquid crystal display according to claim 1, wherein the interlayer-insulation material includes an acryl resin.

4. The liquid crystal display according to claim 3, wherein the acryl resin includes a photo acryl (P/A).

5. The liquid crystal display according to claim 1, wherein the pixel electrode is overlapped with more than one of the data lines adjacent thereto.

6. The liquid crystal display according to claim 5, wherein the pixel electrode is overlapped with more than one of the gate lines formed adjacent thereto.

7. The liquid crystal display according to claim 6, wherein the pixel electrode is overlapped with the thin film transistor.

8. The liquid crystal display according to claim 5, wherein the pixel electrode is overlapped with the thin film transistor.

9. The liquid crystal display according to claim 1, wherein the pixel electrode is overlapped with more than one of the gate lines adjacent thereto.

10. The liquid crystal display according to claim 9, wherein the pixel electrode is overlapped with the thin film transistor.

11. The liquid crystal display according to claim 1, wherein the pixel electrode is overlapped with the thin film transistor.

12. A liquid crystal display, comprising:
liquid crystal cells arranged in a matrix defined by a plurality of gate lines and data lines;
a thin film transistor connected to the data lines in an alternating pattern based upon an arrangement of the data lines included in the liquid crystal cells;
a data driver supplying a video signal to the liquid crystal cells and shifting the video signal by one channel to the right to drive the data lines;
a pixel electrode associated with each of the liquid crystal cells, the pixel electrode having a rectangular shape; and
an interlayer-insulation material formed by an organic insulation film having a dielectric constant less than about 4 and located between the data line and the pixel electrode associated with each of the liquid crystal cells.

13. The liquid crystal display according to claim 12, wherein the pixel electrode is overlapped with a data line.

14. The liquid crystal display according to claim 12, wherein the pixel electrode is overlapped with a gate line.

15. The liquid crystal display according to claim 12, wherein the pixel electrode is overlapped with a gate line, a data line and the thin film transistor.

16. A method of fabricating a liquid crystal display, comprising:
forming a plurality of gate electrodes and gate lines on a first substrate;
forming a gate insulation film on the gate electrodes and the gate lines;
forming a semiconductor layer on the gate insulation film;
forming source electrodes and drain electrodes on the semiconductor layer;
forming data lines connected to the source electrodes, the data lines and the gate lines defining a plurality of liquid crystal cells in a matrix;
forming an organic insulation film having a dielectric constant less than about 4 to cover the data lines, the source electrodes and the drain electrodes; and
forming a pixel electrode on the organic insulation film in each of the liquid crystal cells, the pixel electrode contacting one of the drain electrodes.

17. The method of fabricating a liquid crystal display according to claim 16, wherein the organic insulation film is formed by benzocyclobutene (BCB).

18. The method of fabricating a liquid crystal display according to claim 16, wherein the organic insulation film is formed by acryl resin.

19. The method of fabricating a liquid crystal display according to claim 16, wherein the organic insulation film is formed by a photo acryl (P/A) of acryl resin.

20. The method of fabricating a liquid crystal display according to claim 16, further comprising overlapping the pixel electrode with more than one of the data lines located adjacent thereto.

21. The method of fabricating the liquid crystal display according to claim 20, further comprising overlapping the pixel electrode with at least one of the gate lines.

22. The method of fabricating the liquid crystal display according to claim 21, further comprising overlapping the pixel electrode with one of the source electrodes, one of the drain electrodes and one of the gate electrodes.

23. The method of fabricating the liquid crystal display according to claim 20, further comprising overlapping the pixel electrode with one of the source electrodes, one of the drain electrodes and one of the gate electrodes.

24. The method of fabricating a liquid crystal display according to claim 16, further comprising overlapping the pixel electrode with more than one of the gate lines located adjacent thereto.

25. The method of fabricating the liquid crystal display according to claim 24, further comprising overlapping the pixel electrode with one of the source electrodes, one of the drain electrodes and one of the gate electrodes.

26. The method of fabricating a liquid crystal display according to claim 16, further comprising overlapping the pixel electrode with one of the source electrodes, one of the drain electrodes and one of the gate electrodes.

27. The method of fabricating a liquid crystal display according to claim 16, wherein the pixel electrode has a rectangular shape having four sides, an entire length of each of the four sides being parallel to either one of the data lines or one of the gate lines.
